(19) United States
(12) Patent Application Publication
(10) Pub. No.: US 2005/0245339 A1
(43) Pub. Date: Nov. 3, 2005

(54) Power transmission belt and method of making same

(76) Inventor: Willi Ollenborger, Bevern (DE)

Correspondence Address: ROBERT W. BECKER & ASSOCIATES, Suite B, 707 Highway 66 East, Tijeras, NM, 87059, US

(21) Appl. No.: 11/121,298

(22) Filed: May 3, 2005

(30) Foreign Application Priority Data
May 3, 2004 (DE) 10 2004 021 522.7

(51) Int. Cl. F16G 5/00; F16G 9/00

(52) U.S. Cl. 474/263; 474/237

(57) ABSTRACT

A power transmission belt comprising a belt back, a first, fiber-free, section of vulcanized elastomer vulcanized on the belt back, a load-carrying section embedded between the belt back and the first section, and a second section of vulcanized elastomer vulcanized on the first section, wherein fibers are mixed into the second section.

The instant application should be granted the priority date of May 3, 2004, the filing date of the corresponding German patent application 10 2004 021 522.7.

### BACKGROUND OF THE INVENTION

The present invention relates to a power transmission belt or drive belt, and method of making the same, wherein the belt comprises a belt back and a main body of vulcanized rubber or rubber-like material (also designated “elastomer” in the following) and a load-carrying section that is embedded between the belt back and the main body, whereby pursuant to DE 100 16 351 C1, the main body is essentially provided only in its movement-transferring outer surface regions with fibers. The invention relates in particular to frictionally engaging drive or power transmission belts in the form of V-belts and ribbed V-belts.

Regardless of their areas of use, high requirements are placed upon drive belts with regard to resistance to wear, noise, and dynamic load capacity.

To optimize the belt characteristics, it is customary to mix fibers into the rubber mixture of the main body in the total thickness of the belt rubber, although the fibers are essentially needed only in the movement transferring outer surface regions.

In an endeavor to reduce the amount of often expensive fibers, it is known from DE 100 16 351 C1 to provide only the belt surface, or a portion of the surface and preferably only the movement transferring portion of the surface, with a flocking material of, in particular, short fibers, whereby preferably the predominant quantity of the fibers have only a partial length thereof embedded into the surface. For the flocking with fibers, the belt surface of the unvulcanized belt is prepared by the provision of a solvent, or by the previous application of an adhesive or an adhesive solution, in such a way that the fibers can adhere to the surface. The fibers are then mechanically applied by sprinkling, blowing or shaking, or with the aid of an electrical field, or by combinations of these methods. This method of applying the fibers is expensive.

It is therefore an object of the present invention to provide a drive or power transmission belt in such a way that accompanied by the least possible use of fibers, the manufacture of the belt is simplified.

### BRIEF DESCRIPTION OF THE DRAWING

This object, and other objects and advantages of the invention will appear more clearly from the following specification in conjunction with the accompanying schematic drawings, in which:

FIG. 1 is a cross-sectional view showing the build-up of a belt blank; and,

FIG. 2 is a cross-sectional view showing the build-up of a ribbed V-belt after the molding process and the vulcanization.

### SUMMARY OF THE INVENTION

To realize the aforementioned object, the drive belt of the present application is characterized in that the main body is comprised of a first, fiber-free, section that is vulcanized on the belt back, and a second section that is vulcanized on the first section and into which are mixed fibers.

For producing such a belt, after disposing or winding the individual plies or layers onto one another, it is necessary to perform only a single vulcanizing step without having to undertake additional flocking measures.

During the manufacture of a ribbed V-belt, using during the vulcanization process the molding method, which is economically advantageous relative to the so-called grinding process, the ribs are essentially impressed into the smooth, unvulcanized belt blank, which is comprised of belt back, load-carrying section, and the first and second sheet-like sections of the main body, whereby the fibers that are mixed into the second section follow the rib contour.

The surfaces of the ribs of the belt produced by the molding process can subsequently additionally be ground or roughened, as proposed, for example, in DE 100 16 351 A1 or in U.S. Pat. No. 5,904,630, in order to work out or break off the fibers that are distributed in the mixture and to obtain a surface having a textile character, for example at the fibers disposed at the surface.

Fiber materials that are preferably used are the customary fibers, mentioned, for example, in DE 100 16 351 A1, such as cotton and viscose, and mixtures derived therefrom, polyester, polyamides such as nylons, or aramids having various characteristics.

The belt back is preferably comprised of a textile material, a transverse cord and/or a preferably fiber-reinforced rubber mixture, for example based on polybutadiene (BR), polychloroprene (CR), elastomer copolymers of styrene and butadiene (SBR), acrylonitrile-butadiene rubber (NBR), hydrogenated acrylonitrile-butadiene rubber (HNBR), acrylated chlorosulfonated polyethylene (ACSM), ethylene-propylene rubber (EPM) or preferably ethylene-propylene-diene terpolymer rubber (EPDM). The load carriers are preferably comprised of polyamides, polyesters, aramids, glass or other pull resistant materials.

The main body is preferably comprised of the same elastomers as described above in conjunction with the belt back.

The belt characteristics can be influenced by various elastomer materials for the belt back and for the two sections of the main body, the thickness of the individual sections, different accelerator systems for the elastomers and/or by the introduction of various additives that are suitable for the respective purpose.

Although this increases the expense, the belt characteristics can be even further improved by additionally applying to the movement transferring upper surface regions various materials, for example an additional flocking via suitable fibers or by other substances, for example lubricants or the like.

The inventive build-up is suitable for different types of drive belts, for example, V-belts, ribbed V-belts, power bands, toothed belts, flat belts, or open-sided toothed V-belts.

The invention will be described in the following with the aid of a ribbed V-belt, and a preferred method of manufacturing the same.

### DESCRIPTION OF SPECIFIC EMBODIMENTS

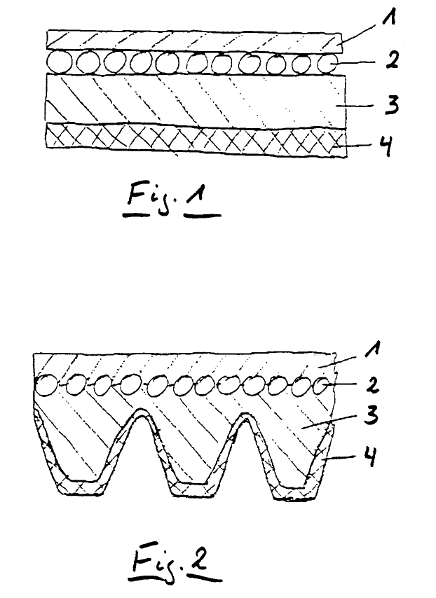

Referring now to the drawing in detail, the blank of FIG. 1 comprises a belt back 1, a load-carrying section 2, a first, fiber-free, main body section 3, and a second main body section 4 having fibers mixed therein, generally relatively short fibers, for example aramid fibers or the like.

In conformity with the molding process known for the manufacture of ribbed V-belts, during the molding and vulcanization processes, the ribs are impressed into the essentially smooth surface of the blank. The layer thickness of the “fiber-filled” second section 4, dictated by the molding process, decreases from the tips of the ribs to the bases of the ribs as a function of the distance between the tips of the ribs and the bases of the ribs, for example by about 50%. Since during operation of a ribbed V-belt or a simple V-belt, the wear at the tips of the ribs is particularly great, the greatest thickness of the fiber-filled section 4 is advantageously in the region of the tips of the ribs.

With the blank illustrated in FIG. 1, as illustrated the thicknesses of the sections or layers 3 and 4 are different, with the thickness of the fiber-free, main body section 3 preferably being 1.5 to 5, and more preferably 1.5 to 3, times the thickness of the second, fiber-filled, main body section 4. Thus, for example, with a fiber-free section 3 having a thickness of 1.55 mm, the thickness of the “fiber-filled” section 4 can be about 0.65 mm.

The viscosity and thicknesses of the two sections 3 and 4 must be coordinated with one another in such a way that a closed and adequately dense surface of the fiber mixture is ensured during the molding process.

The specification incorporates by reference the disclosure of German priority document 10 2004 021 522.7 filed May 3, 2004.

The present invention is, of course, in no way restricted to the specific disclosure of the specification and drawing, but also encompasses any modifications within the scope of the appended claims.

1. A power transmission belt, comprising:
a belt back;
a first, fiber-free, section of vulcanized elastomer vulcanized on the belt back;
a load-carrying section embedded between the belt back and the first section; and
a second section of vulcanized elastomer vulcanized on the first section, wherein fibers are mixed into the second section.

2. A power transmission belt according to claim 1, wherein said first and second sections are comprised of ethylene-propylene-diene terpolymer rubber (EPDM).

3. A power transmission belt according to claim 1, wherein said first and second sections are comprised of an elastomer based on at least one of the group consisting of polybutadiene, polychloroprene rubber, elastomer copolymers of styrene and butadiene rubber, hydrogenated acrylonitrile butadiene rubber, acrylated chlorosulfonated polyethylene, and ethylene-propylene rubber.

4. A power transmission belt according to claim 1, wherein load carriers of said load-carrying section are comprised of polyamides, polyesters, aramids, glass, or some other pull-resistant material.

5. A power transmission belt according to claim 1, which is in the form of a ribbed V-belt.

6. A power transmission belt according to claim 5, wherein a layer thickness of said second, fiber-containing section decreases from tips of the ribs to bases of the ribs.

7. A method of producing a ribbed V-belt, including the steps of:
producing a belt blank by sequentially disposing on one another a belt back, a load-carrying section, a first, fiber-free, main body layer, and a second, fiber-filled, main body layer; and
impressing ribs into said belt blank using a molding process.

8. A method according to claim 7, wherein said first, fiber-free, main body layer has a thickness that is 1.5 to 5 times that of said second, fiber-filled, main body layer.
